(19) United States
(12) Patent Application Publication
(10) Pub. No.: US 2004/0074380 A1
(43) Pub. Date: Apr. 22, 2004

(54) Packaged preamp

(76) Inventor: Lawrence R. Fishman, Winchester, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/649,369

(22) Filed: Aug. 27, 2003

Related U.S. Application Data
(60) Provisional application No. 60/407,537, filed on Aug. 30, 2002.

(51) Int. Cl. G10H 1/46; G10H 3/12

(52) U.S. Cl. 84/741

(57) ABSTRACT

A packaged preamp with an integral pickup, a battery holder, an output jack, and a plurality of control mechanisms. The packaged preamp can be mounted on a flat, curved, or variably curved side of an acoustic guitar body, such as a lower side away from the guitar player, while allowing optimal access to the output jack and the controls. The pickup is pre-wired into the preamp and requires only a mechanical attachment within the guitar. The output jack is integral to the preamp's front panel, the battery is accessed through a cover on the front panel, and the controls are accessed through the front panel. Once the pickup is attached inside the guitar, the packaged preamp is attached within a pre-cut opening in the side of the guitar, thereby completing the installation of the preamp.

### CROSS REFERENCE TO RELATED APPLICATIONS

This application claims priority of U.S. Provisional Patent Application No. 60/407,537 filed Aug. 30, 2002 entitled PACKAGED PREAMP.

### STATEMENT REGARDING FEDERALLY SPONSORED RESEARCH OR DEVELOPMENT

N/A

### BACKGROUND OF THE INVENTION

The present invention relates generally to electronics enclosures and assemblies, and more specifically to a packaged preamplifier assembly mountable on a side of a musical instrument such as a guitar or similar stringed instrument.

Enclosures for preamplifier (“preamp”) circuits are known that may be mounted on guitars and similar stringed instruments. A conventional preamp enclosure configured for use with an acoustic guitar is described in U.S. Pat. No. 6,278,059 (“the '059 patent”) filed Nov. 3, 1999 entitled ELECTRONICS HOUSING HAVING A FLEXIBLE OUTER FLANGE and assigned to the same assignee as the present invention. As disclosed in the '059 patent, the preamp enclosure is configured to hold a battery and to mount on either a flat or curved surface of the guitar body.

Although the preamp enclosure described in the '059 patent represents a significant advance in the art of electronics enclosures, it has several shortcomings. For example, the preamp enclosure does not provide for easily attaching a signal input to a preamp circuit housed within the enclosure. The preamp enclosure also has no provisions for easily accessing a signal output generated by the preamp circuit or for easily attaching the signal output to an output jack. Moreover, the manner in which a battery is secured and accessed within the preamp enclosure contributes a significant amount of mechanical complexity to the device.

It would therefore be desirable to have a preamp assembly mountable on a side of a musical instrument such as a guitar or similar stringed instrument that avoids the shortcomings of conventional preamp enclosures and assemblies.

### BRIEF SUMMARY OF THE INVENTION

In accordance with the present invention, a packaged preamplifier (“preamp”) assembly is disclosed that can be mounted on a flat, curved, or variably curved surface of a guitar body while providing easier pickup installation, easier output jack connection, and easier battery access. The presently disclosed packaged preamp achieves such benefits via a simplified construction that requires no wiring or soldering when installing the preamp in the guitar body.

In one embodiment, the packaged preamp comprises a housing, a flexible mounting flange, a Printed Circuit (PC) board subassembly including a plurality of PC boards and at least one connector, at least one pickup for inputting an input signal, at least one output jack for outputting an output signal, and a plurality of control mechanisms, e.g., for volume and tone. The housing includes a battery holder with a captive cover that can be securely snapped into place. The plurality of PC boards is configured to hold all of the circuitry necessary for implementing the preamp. In the preferred embodiment, the control mechanisms comprise a pair of thumb-wheel potentiometer controls for adjusting the volume and tone.

In a process of assembling the packaged preamp, the PC boards are interconnected via the connector. Next, the pickup leads are electrically shielded and attached to one of the PC boards. Battery terminals associated with the integral battery holder are then connected to one of the PC boards. Next, the output jack is directly attached to one of the PC boards. The PC board assembly is then inserted in the housing. Next, the flexible mounting flange is attached to the housing by one or more fasteners.

Because of the simplified construction of the packaged preamp, manufacturing costs and installation costs are reduced, thereby allowing the device to be economically installed in a high volume of stringed musical instruments, including low-cost models. Further, because a typical installation of the packaged preamp requires no soldering and no modification of the instrument other than the preparation of an opening for the preamp device, the likelihood of assembly or installation error is significantly reduced, thereby resulting in fewer potential failure modes and increased reliability.

Further, because the output jack is integrated with the packaged preamp, there is no need to drill a separate hole through the instrument to accommodate the jack. The packaged preamp functions as a structural reinforcement for the output jack, thereby obviating the need to provide a separate reinforcement in the event low-cost output jack models are employed.

Moreover, the wiring for the packaged preamp is simplified because only the pickup leads need to be connected to the preamp—no separate cable is required to connect the output jack to the preamp circuitry. The internal assembly of the packaged preamp is also simplified by a PC board spacer that both separates and aligns the boards. Instead of welding the PC boards in place, the boards are friction fit onto the PC board spacer. In addition, the packaged preamp may be mounted on any side of the instrument to maintain optimal control usability.

Other features, functions, and aspects of the invention will be evident from the Detailed Description of the Invention that follows.

### BRIEF DESCRIPTION OF THE SEVERAL VIEWS OF THE DRAWINGS

The invention will be more fully understood with reference to the following Detailed Description of the Invention in conjunction with the drawings of which:

FIG. 1 is a perspective view of a packaged preamp mounted on a side of an acoustic guitar according to the present invention;

FIG. 2 is a perspective front view of the packaged preamp of FIG. 1;

FIG. 3 is a perspective view of the packaged preamp of FIG. 1 showing a pre-wired pickup and an open battery holder;

FIG. 4 is a perspective rear view of the back of the packaged preamp of FIG. 1;

FIG. 5 is an exploded perspective rear view of the packaged preamp of FIG. 1;

FIG. 6 is a perspective front view of an alternative embodiment of the packaged preamp of FIG. 1 including three control mechanisms, a pickup, and a microphone;

FIG. 7 is a perspective view of a printed circuit board spacer included in the packaged preamp of FIG. 1;

FIG. 8 is a flow diagram of a method of assembling the packaged preamp of FIG. 1; and

FIG. 9 is a flow diagram of a method of installing the packaged preamp of FIG. 1 in a stringed musical instrument.

### DETAILED DESCRIPTION OF THE INVENTION

U.S. Provisional Patent Application No. 60/407,537 filed Aug. 30, 2002 entitled PACKAGED PREAMP is incorporated herein by reference.

A packaged preamplifier (“preamp”) assembly is provided that is mountable on a side of a musical instrument such as a guitar or other similar stringed instrument. The presently disclosed packaged preamp includes a housing having an integral battery holder, and at least one Printed Circuit (PC) board disposed in the housing having pickup input leads and an output jack directly attached thereto, thereby allowing easier battery access, easier pickup installation, and easier output jack connection.

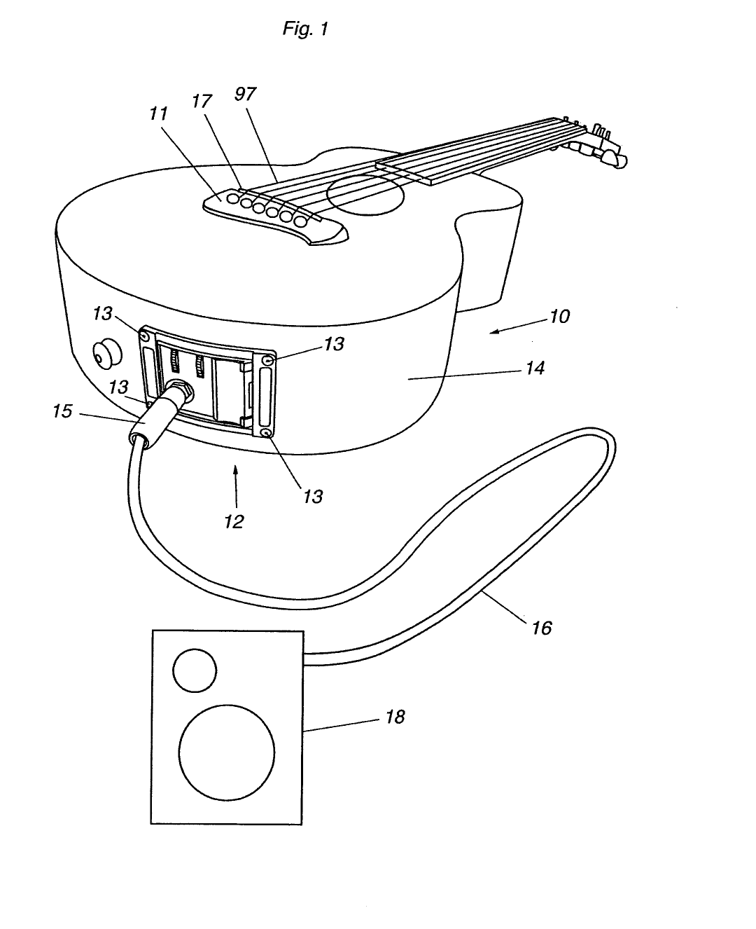

FIG. 1 depicts an illustrative embodiment of a packaged preamp 12 mounted on a side of an acoustic guitar 10, in accordance with the present invention. In the illustrated embodiment, the packaged preamp 12 is secured to the side of a lower bout 14 of the guitar 10 by a plurality of mounting screws 13 or any other suitable fasteners. It should be understood that the packaged preamp 12 may alternatively be mounted on a side of a hollow body electric guitar, a semi-hollow body electric guitar, a solid body electric guitar, a ukulele, a mandolin, a violin, a viola, a cello, a bass violin, or any other suitable stringed musical instrument.

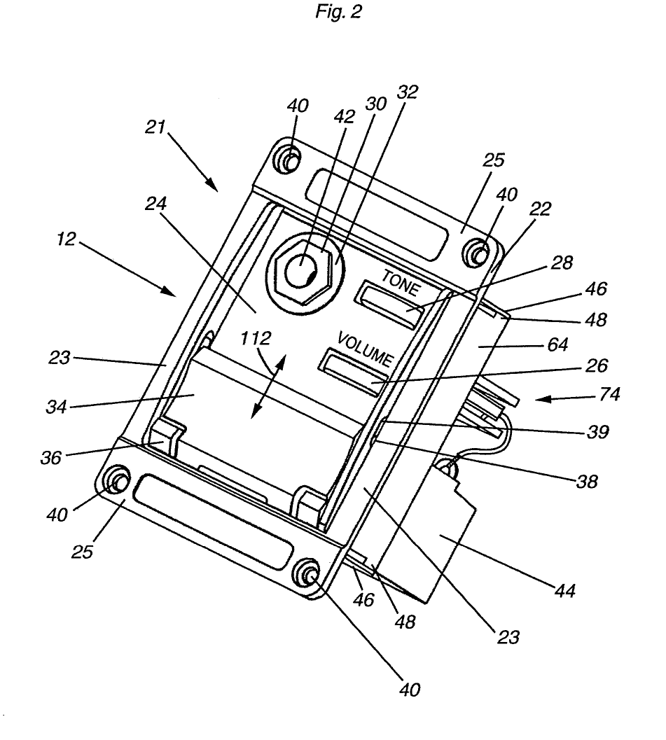

FIG. 2 depicts the packaged preamp 12 comprising a housing 21 that includes an electronics enclosure 64 and a battery holder 44. The packaged preamp 12 further comprises a flexible outer mounting flange 22, a face portion including an inner bezel 24, a Printed Circuit (PC) board assembly 74 disposed within the electronics enclosure 64, thumb-wheel volume and tone controls 26 and 28 and an output jack 42 disposed on the inner bezel 24, and a captive cover 34 for the battery holder moveably coupled to the face of the packaged preamp. It should be noted that the packaged preamp 12 provides unobstructed access to the thumb-wheel volume and tone controls 26 and 28, the output jack 42, and the battery holder cover 34 disposed on the face of the device.

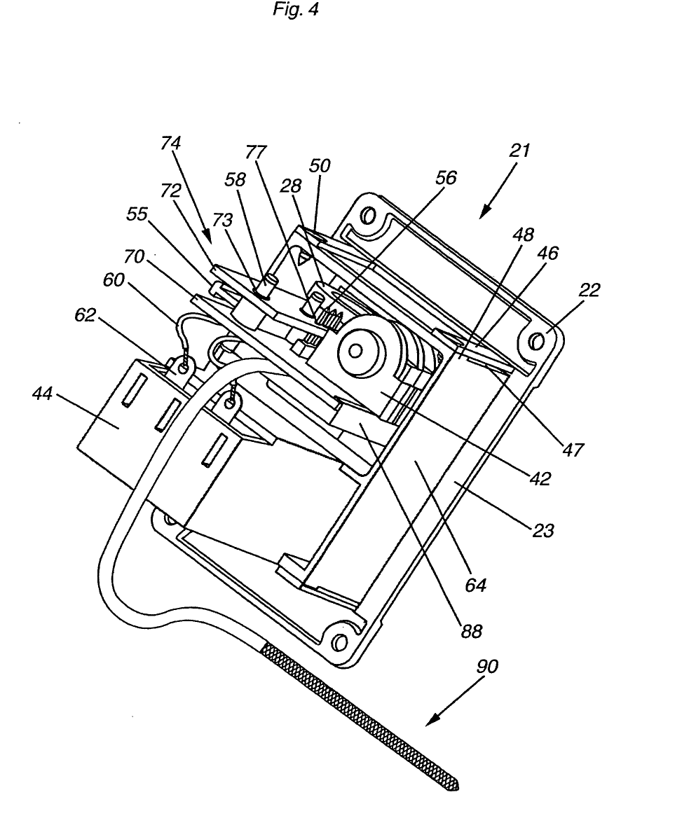

Specifically, the flexible mounting flange 22 includes opposing flange end sections 25 for mounting the packaged preamp 12 on the side of the guitar 10 (see FIG. 1), a plurality of flange ligaments 23 interconnecting the end sections 25, and a plurality of connecting ligaments 46 for connecting the mounting flange 22 to the electronics enclosure 64. The flexible mounting flange 22 is attached to the electronics enclosure 64 by the connecting ligaments 46 and corresponding connecting ligament screws 50 (see FIG. 4).

As shown in FIG. 4, connecting ligament openings 47 are separated from the electronics enclosure 64 by integrally molded connecting ligament spacers 48 (see FIG. 2). The ligament openings 47 are configured to give the connecting ligaments 46 room to bend when the flexible outer flange 22 is bent. The two substantially rigid outer flange sections 25 have a plurality of screw holes 40 formed therethrough and sized to accommodate the plurality of mounting screws 13 securing the packaged preamp 12 to the guitar. The outer flange sections 25 are connected to each other by the flange ligaments 23, which are capable of bending to conform to a curved surface of the guitar body.

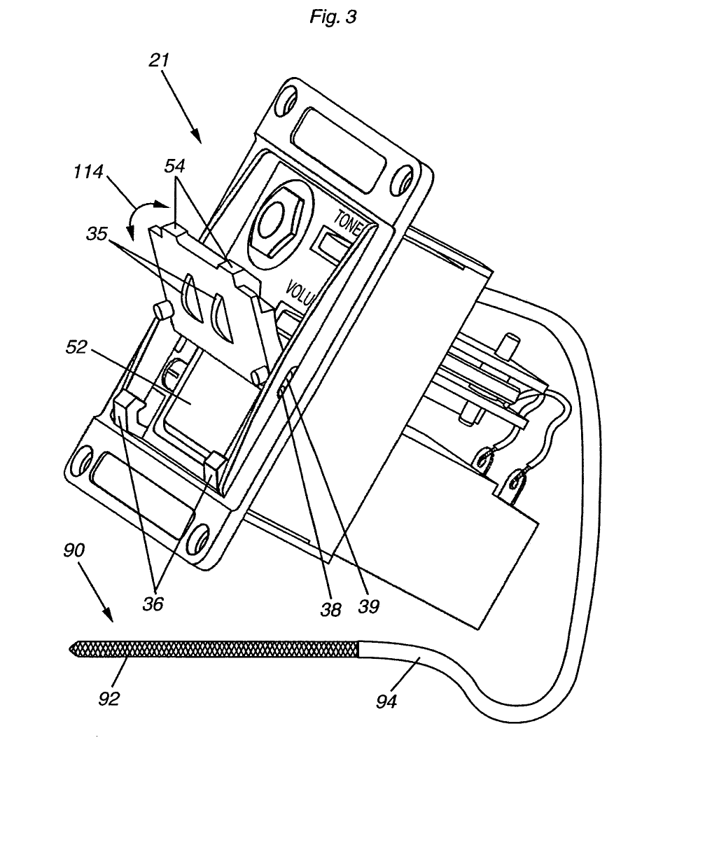

As shown in FIG. 2, the battery holder cover 34 has a pair of pivot pins 38 disposed in corresponding slots 39 formed in the bezel 24 of the packaged preamp 12, which further includes a plurality of cover retainers 36 for engaging corresponding locking surfaces 54 (see FIG. 3) on the cover 34. Specifically, the pivot pins 38 and the corresponding slots 39 are configured to allow the closed cover 34 to slide, as depicted by a directional arrow 112 (see FIG. 2), a distance sufficient to free the cover locking surfaces 54 from the cover retainers 36. The cover 34 may then be opened by rotating it, as depicted by a directional arrow 114 (see FIG. 3), about the axis of the pivot pins 38 to permit access to a battery 52 within the battery holder 44 (see FIG. 3). The cover 34 may be closed by rotating it, as depicted by the directional arrow 114, to enclose the battery 52 within the battery holder 44, and by sliding it, as depicted by the directional arrow 112, into a locking position, thereby engaging the cover locking surfaces 54 under the cover retainers 36.

Battery terminals 62 (see FIG. 4) at least partially disposed within the holder 44 are configured to generate sufficient spring force to urge the battery 52 against ribs 35 (see FIG. 3) formed on an inner surface of the closed cover 34, thereby securely engaging the cover locking surfaces 54 in the cover retainers 36 and avoiding any unwanted movement of the closed cover 34. In this configuration, the battery holder cover 34 may be opened by combined actions of pressing and sliding the cover 34 to disengage the locking surfaces 54 from the retainers 36.

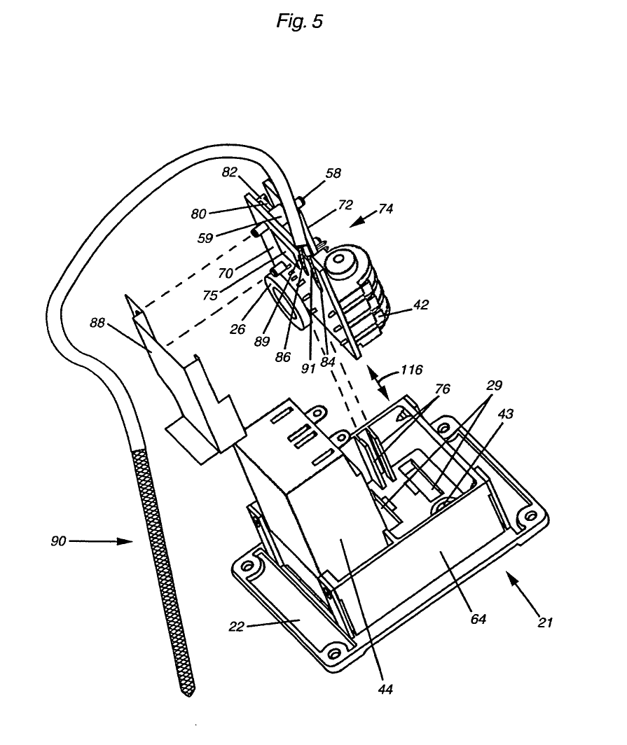

The battery 52 supplies power to preamp circuitry 75 (see FIG. 5) via the battery terminals 62 and battery terminal wires 60 (see FIG. 4). An output plug 15 (see FIG. 1) coupled to a shielded cable 16 (see FIG. 1) is configured to engage the output jack 42 and to actuate an internal shorting contact, thereby allowing the user to selectively turn the power “on” and “off”. As shown in FIG. 1, the cable 16 is connected between the plug 15 and an amplifier/speaker system 18.

As shown in FIG. 2, an output jack nut 30 and an output jack washer 32 are used to fasten the output jack 42 in place within the preamp housing 21. Because the output jack 42 is connected to the PC board assembly 74, the output jack nut and washer 30 and 32 not only secure the output jack 42 to the face of the housing 21, but they also secure the entire assembly 74 within the electronics enclosure 64. As shown in FIG. 4, the PC board assembly 74 comprises a plurality of PC boards, e.g., a PC board 70 for mounting the output jack 42 and a secondary PC board 72, and a PC board spacer 55. The combination of the PC board spacer 55 and a PC board connector including PC board connecting leads 56 joins the output jack mounting board 70 to the secondary board 72 in a predetermined fixed orientation.

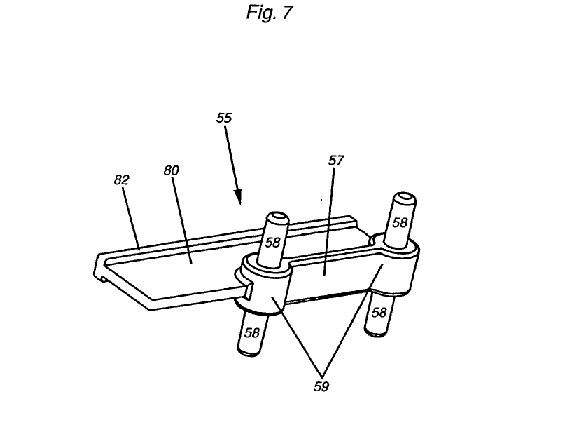

FIG. 7 depicts the PC board spacer 55, which includes a spacer bar 57 having a respective circuit board support boss 59 at each end thereof, a plurality of PC board locating pins 58 emerging from the ends of the board support bosses 59, a support member 80 transversely disposed relative to the support bosses 59 and the spacer bar 57, and a guide rail 82 transversely disposed relative to the support member 80 opposite the bosses 59. To properly orient the output jack mounting board 70 relative to the secondary board 72, the PC board locating pins 58 are inserted through respective locating holes 73 formed in the PC boards 70 and 72 (see FIG. 4). Further, to secure the PC board assembly 74 to the electronics enclosure 64, the guide rail 82 of the PC board spacer 55 is slidingly engaged in mounting rails 76 protruding from an inner surface of the enclosure 64.

As shown in FIGS. 4-5, the output jack 42 and the thumb-wheel volume control 26 are mounted on the output jack mounting board 70, and the thumb-wheel tone control 28 is mounted on the secondary board 72. It is noted that the circuitry 75 for implementing the pre-amplification function may be disposed on one or both of the PC boards 70 and 72. The packaged preamp 12 comprises a pre-wired pickup 90 including a pickup body 92, a signal output lead 91, a signal shield 89, and a pickup cable 94 (see also FIG. 3), and a foil shield 88 (see FIGS. 4-5). In the illustrated embodiment, the pickup 90 is connected to the output jack mounting board 70 by attaching the signal output lead 91 to an input pad 84 and by attaching the signal shield 89 to a ground pad 86 disposed on the PC board 70 (see FIG. 5). Further, the foil shield 88 is disposed over the preamp circuitry 75 and the input and ground pads 84 and 86 on the PC board 70, and connected to ground potential.

The pickup body 92 is most conveniently installed by inserting it from the inside of the acoustic guitar 10 through a hole drilled through a bridge 11 (see FIG. 1) of the guitar. The pickup body 92 is then clamped between a saddle 17 (see FIG. 1) of the guitar and the bridge 11 by guitar strings 97 (see FIG. 1). In this way, vibrations in the strings 97 are mechanically coupled to the pickup body 92, thereby inducing an electrical signal that is transmitted through the pickup cable 94. The electrical signal appearing between the signal output lead 91 and the signal shield 89 is then transmitted to the preamp circuitry 75 via the input and ground pads 84 and 86 for subsequent processing.

For example, the battery 52 disposed in the battery holder 44 may comprise a standard 9-volt battery or any other suitable type of battery. Further, the pickup 90 may be of the piezoelectric type or any other suitable type of pickup. Moreover, the housing 21 may be molded from a plastic material such as Nylon 6 or any other suitable material, and the battery holder lid 34 may be molded from a glass-filled plastic material or any other suitable material to increase its stiffness. In the preferred embodiment, the bezel 24, the battery holder 44, and the electronics enclosure 64 are molded as a single piece.

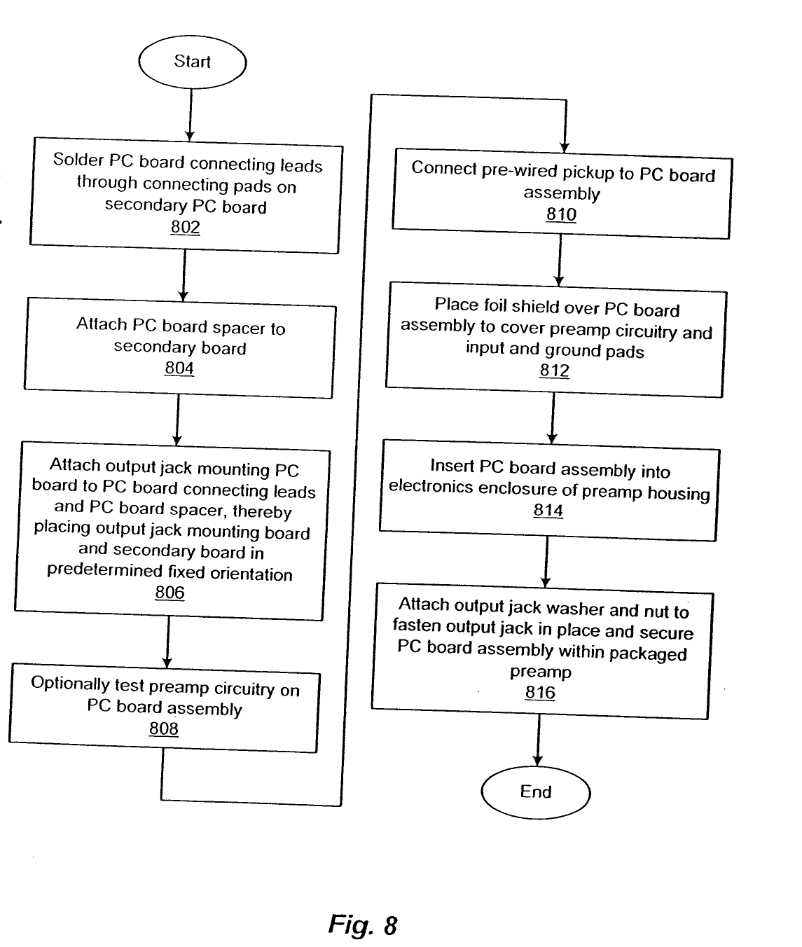

An illustrative method of assembling the presently disclosed packaged preamp is illustrated by reference to FIG. 8. As depicted in step 802, the connecting leads of the PC board connector are soldered through connecting pads (see the pads 77 in FIG. 4) on the secondary PC board. Next, the PC board spacer is attached, as depicted in step 804, to the secondary board by inserting the PC board locating pins of the PC board spacer through respective locating holes (see the holes 73 in FIG. 4) in the board. The output jack mounting PC board is then attached, as depicted in step 806, to the PC board connecting leads and the PC board spacer, thereby placing the output jack mounting board and the secondary board in the predetermined fixed orientation. It is noted that the PC board spacer is aligned so that the guide rail faces away from the output jack. Next, the preamp circuitry disposed on the PC boards is optionally tested, as depicted in step 808. The pre-wired pickup is then connected, as depicted in step 810, to the PC board assembly by soldering the signal output lead to the input pad and by soldering the signal shield to the ground pad. Next, the foil shield is placed over the PC board locating pins of the PC board assembly to cover the preamp circuitry and the input and ground pads, as depicted in step 812. It is noted that the foil shield is connected to ground potential. The PC board assembly is then inserted, as depicted in step 814, into the electronic enclosure by sliding the guide rail (as depicted by a directional arrow 116) between the mounting rails until the assembly contacts the bezel, thereby causing the thumb-wheel volume and tone controls to protrude through respective thumb-wheel openings (see the openings 29 in FIG. 5) and the output jack to press against a jack opening (see the opening 43 in FIG. 5). Next, the output jack nut and the output jack washer are attached, as depicted in step 816, to fasten the output jack in place, thereby securing the entire PC board assembly within the electronics enclosure of the packaged preamp.

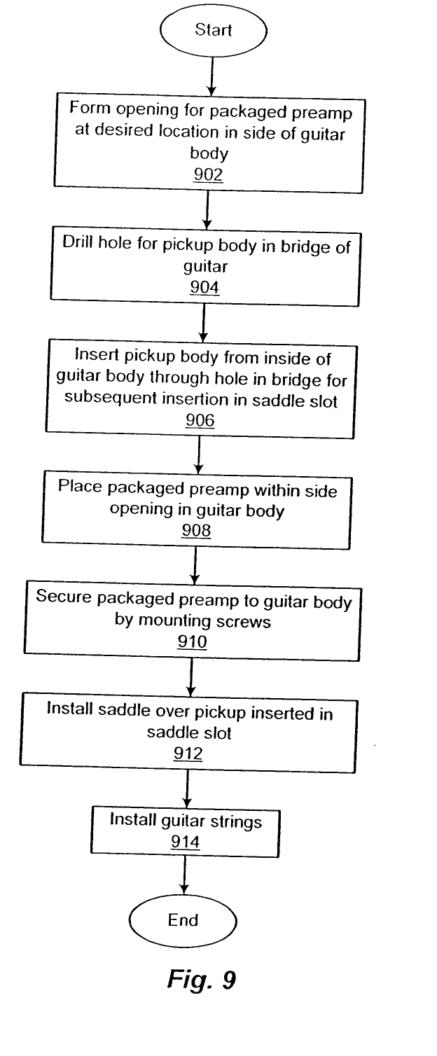

An illustrative method of installing the presently disclosed packaged preamp in an acoustic guitar body is illustrated by reference to FIG. 9. As depicted in step 902, an opening is formed for the packaged preamp at a desired location in the side of the guitar body by, e.g., drilling and/or cutting. A hole is then drilled, as depicted in step 904, for the pickup body in the bridge of the guitar. Next, the pickup body is inserted, as depicted in step 906, from the inside of the guitar body through the hole in the bridge for subsequent insertion into the saddle slot. The packaged preamp is then placed, as depicted in step 908, within the side opening. The packaged preamp is then secured, as depicted in step 910, to the guitar body by the plurality of mounting screws. Next, the saddle is installed, as depicted in step 912, over the pickup inserted in the saddle slot. Finally, the guitar strings are installed, as depicted in step 914, on the guitar.

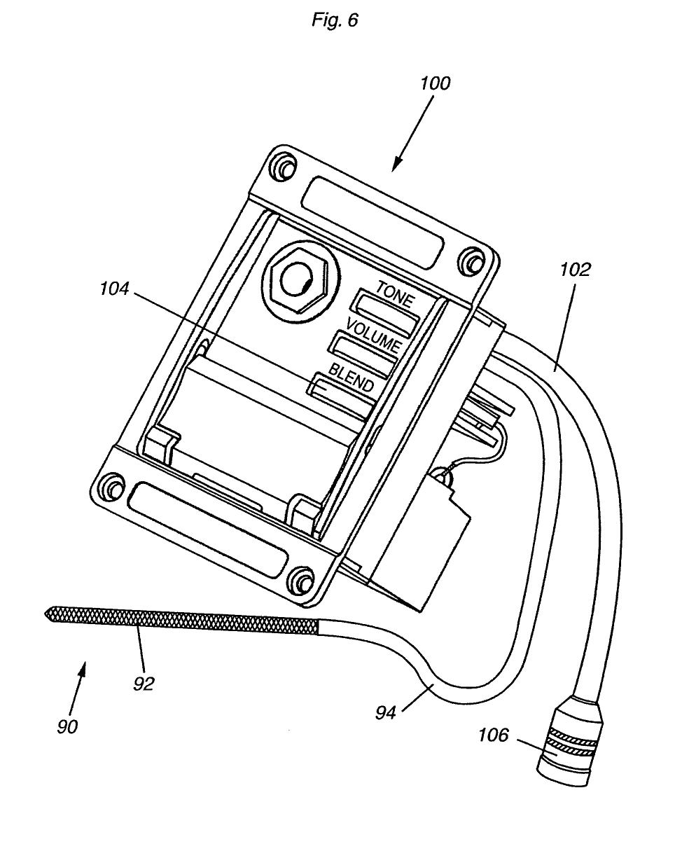

Having described the above illustrative embodiment, other alternative embodiments or variations may be made. For example, FIG. 6 depicts a packaged preamp 100 with a blend control 104 in addition to the volume and tone controls, as described above. The packaged preamp 100 further includes a pre-wired microphone 106 in addition to the above-described pre-wired pickup 90. The pre-wired microphone 106 is connected to the PC board assembly 74 through a gooseneck connection 102. Access to the thumb-wheel blend control 104 is added to the inner bezel 24 to allow the user to blend signals provided by the pre-wired pickup and microphone 90 and 106. It should be understood that, in addition to or instead of the pre-wired pickup 90, the packaged preamp 100 may alternatively include a vibration sensitive transducer, a force sensor, an accelerometer, a pressure sensor, or any other suitable input device.

Further, the output jack may be alternatively configured for optionally supplying two separate channels of output signals. Moreover, depending on the preamp circuitry employed, the output signals may be provided either as a blended output signal or as two separate buffered signals via, e.g., a stereo jack.

Other variations include soldering mechanical connectors such as terminal blocks to the input and ground pads, thereby allowing the pickup to be mechanically attached during assembly instead of being attached by soldering. Further, the battery holder cover may be joined so that motions other than pivoting, e.g., a purely sliding motion, may be employed for opening and closing the cover. Moreover, the battery terminals may be soldered directly to one of the PC boards without requiring wires to make the electrical connection. The flexible outer flange and the electronics enclosure may also be molded as a single piece.

It will further be appreciated by those of ordinary skill in the art that modifications to and variations of the above-described packaged preamp may be made without departing from the inventive concepts disclosed herein. Accordingly, the invention should not be viewed as limited except as by the scope and spirit of the appended claims.

What is claimed is:

1. A preamplifier assembly for a musical instrument, comprising:
a housing including a face portion and a battery holder, the battery holder being configured to hold a battery, the housing being connectable to a surface of the musical instrument while allowing unobstructed user access to the face portion of the housing;
a cover for securely enclosing the battery within the battery holder, the cover being movably mounted on the face portion of the housing to allow the user to access the battery within the battery holder;
preamplifier circuitry disposed in the housing; and
an output connector operatively connected to the preamplifier circuitry, the output connector being mounted on the face portion of the housing.

2. The preamplifier assembly of claim 1 further including at least one control mechanism operatively connected to the preamplifier circuitry, the control mechanism being configured to control at least one characteristic of an output signal provided by the preamplifier circuitry via the output connector.

3. The preamplifier assembly of claim 2 wherein the face portion of the housing is configured to allow the user to access the control mechanism.

4. The preamplifier assembly of claim 2 wherein the signal characteristic controlled by the control mechanism is selected from the group consisting of volume and tone.

5. The preamplifier assembly of claim 1 wherein the housing includes an electronics enclosure, the electronics enclosure being configured to house the preamplifier circuitry.

6. The preamplifier assembly of claim 5 wherein the preamplifier circuitry is secured within the electronics enclosure via the mounting of the output connector on the face portion of the housing.

7. The preamplifier assembly of claim 1 wherein the housing further includes a mounting flange configured to connect the housing to the surface of the musical instrument.

8. The preamplifier assembly of claim 7 wherein the surface of the musical instrument is a planar or contoured surface, and wherein the mounting flange is configured for flexibly and conformably connecting the housing to the planar or contoured surface of the instrument.

9. The preamplifier assembly of claim 1 further including at least one input device operatively connected to the preamplifier circuitry.

10. The preamplifier assembly of claim 9 wherein the input device is selected from the group consisting of a pre-wired pickup, a pre-wired microphone, a vibration sensitive transducer, a force sensor, an accelerometer, and a pressure sensor.

11. The preamplifier assembly of claim 9 wherein the at least one input device includes a first input device and a second input device, the first and second input devices being configured to provide respective input signals to the preamplifier circuitry.

12. The preamplifier assembly of claim 11 further including at least one control mechanism operatively connected to the preamplifier circuitry for adjustably blending the respective input signals provided by the first and second input devices.

13. The preamplifier assembly of claim 12 wherein the face portion of the housing is configured to allow the user to access the control mechanism.

14. The preamplifier assembly of claim 1 wherein the musical instrument is selected from the group consisting of an acoustic guitar, a hollow body electric guitar, a semi-hollow body electric guitar, a solid body electric guitar, a ukulele, a mandolin, a violin, a viola, a cello, and a bass violin.

15. The preamplifier assembly of claim 1 wherein the output connector comprises an output jack.

16. The preamplifier assembly of claim 15 wherein the face portion of the housing is configured to reinforce the output jack.

17. The preamplifier assembly of claim 15 wherein the output jack is configured to receive an output plug, the preamplifier circuitry including a shorting contact configured to be actuated when the output plug is received by the output jack, thereby allowing power to be provided to the preamplifier circuitry.

18. The preamplifier assembly of claim 1 further including a printed circuit board subassembly comprising first and second printed circuit boards and a printed circuit board spacer, the first and second circuit boards being mechanically connected to each other in a predetermined fixed orientation by the circuit board spacer.

19. The preamplifier assembly of claim 18 wherein the preamplifier circuitry is disposed on at least one of the first and second circuit boards.

20. The preamplifier assembly of claim 18 wherein the output connector is connected to a selected one of the first and second circuit boards.

21. The preamplifier assembly of claim 20 wherein the face portion of the housing has an opening formed therethrough, wherein the circuit board assembly is configured to engage the housing, and wherein the first and second circuit boards are oriented to allow the user to access the output connector via the opening when the circuit board assembly engages the housing.

22. The preamplifier assembly of claim 21 wherein the output connector comprises an output jack, the output jack being mounted on the face portion at the opening formed therethrough.

23. A preamplifier housing for a musical instrument, the housing being connectable to a surface of the musical instrument, comprising:
a face portion, the housing being connectable to the surface of the musical instrument while allowing unobstructed user access to the face portion of the housing;
an electronics enclosure configured to house preamplifier circuitry;
a battery holder configured to hold a battery therein for powering the preamplifier circuitry, the face portion of the housing being configured to provide access to the battery holder; and
a cover movably mounted on the face portion of the housing, the cover being configured to enclose the battery within the battery holder.

24. The preamplifier housing of claim 23 wherein the cover is slidably mounted on the face portion of the housing.

25. The preamplifier housing of claim 23 wherein the cover is pivotally and slidably mounted on the face portion of the housing.

26. The preamplifier housing of claim 25 wherein the cover includes at least one cover locking surface and the face portion of the housing includes at least one cover retaining element, the cover retaining element being configured to engage the cover locking surface when the cover encloses the battery within the battery holder.

27. The preamplifier housing of claim 26 wherein the cover has at least one pivot formed thereon, and wherein the face portion of the housing includes a bezel, the bezel having at least one slot formed therein, the slot being configured to receive the pivot.

28. The preamplifier housing of claim 27 wherein the cover is configured to rotate about the pivot to enclose the battery within the battery holder and to open the battery holder to allow the user to access the battery therein, the slot being configured to allow the cover locking surfaces to slidingly engage the cover retaining elements.

29. The preamplifier housing of claim 28 wherein the battery holder has a plurality of battery terminals disposed therein, the cover having at least one rib formed on a surface thereof, the rib being configured to push the battery toward the battery terminals when the cover encloses the battery in the battery holder.

30. The preamplifier housing of claim 29 wherein the terminals are configured to urge the battery against the at least one rib formed on the cover, thereby causing the cover locking surface on the cover to securely engage the cover retaining element on the face portion of the housing.

31. The preamplifier housing of claim 23 further including a mounting flange configured to connect the housing to the surface of the musical instrument.

32. The preamplifier housing of claim 31 wherein the surface of the musical instrument is a planar or contoured surface, and wherein the mounting flange is configured for flexibly and conformably connecting the housing to the planar or contoured surface of the instrument.

33. A method of assembling a preamplifier for a musical instrument, the preamplifier assembly including a housing having a face portion, the housing being configured to connect to a surface of the musical instrument while allowing unobstructed user access to the face portion of the housing, comprising the steps of:
operatively connecting an input device to preamplifier circuitry, the preamplifier circuitry being disposed on at least one printed circuit board of a printed circuit board subassembly;
operatively connecting an output connector to the preamplifier circuitry;
mechanically attaching the output connector to the circuit board subassembly;
disposing the circuit board subassembly having the input device and the output connector connected thereto within the housing, the output connector being in registration with an opening formed through the face portion of the housing; and
mechanically attaching the output connector to the face portion of the housing at the opening formed therethrough, thereby securing the circuit board assembly within the housing and allowing the user to access the output connector via the opening in the face portion.

34. The method of claim 33 wherein the first connecting step includes operatively connecting the input device to the preamplifier circuitry, the input device being selected from the group consisting of a pre-wired pickup, a pre-wired microphone, a vibration sensitive transducer, a force sensor, an accelerometer, and a pressure sensor.

35. The method of claim 33 wherein the second attaching step includes mechanically attaching the output connector to the face portion of the housing at the opening formed therethrough, the output connector comprising an output jack, the output jack being mechanically attached to the face portion of the housing by at least one fastener.

36. The method of claim 33 wherein the circuit board subassembly comprises first and second printed circuit boards and a printed circuit board spacer, and further including the step of disposing the first and second circuit boards on the circuit board spacer to mechanically interconnect the circuit boards in a predetermined fixed orientation, thereby allowing the user to access the output connector via the opening in the face portion when the circuit board subassembly is disposed in the housing.

37. The method of claim 36 wherein the circuit board spacer has a guide rail formed on a length thereof, wherein the housing has mounting rail formed on a surface thereof, and wherein the step of disposing the circuit board subassembly within the housing includes slidingly engaging the guide rail to the mounting rail.

38. The method of claim 33 wherein the housing includes an electronics enclosure for housing the circuit board assembly and a battery holder for holding a battery to power the preamplifier circuitry, the battery being accessible by the user via an opening in the face portion of the housing, and further including the step of attaching a captive cover for the battery holder to the face portion of the housing.

39. The method of claim 38 wherein the battery holder has a plurality of battery terminals disposed therein, and further including the step of operatively connecting the battery terminals to the preamplifier circuitry.

40. A method of installing a preamplifier assembly in a musical instrument, the preamplifier assembly having a housing with a mounting flange for connecting the housing to a surface of the musical instrument, comprising the steps of:
forming a first opening in the musical instrument, the first opening having a size sufficient to receive the housing of the preamplifier assembly;
optionally forming a second opening in the musical instrument, the second opening having a size sufficient to receive a pickup operatively connected to the preamplifier assembly,
installing the pickup on the musical instrument by optionally inserting the pickup through the second opening formed in the musical instrument;
disposing the housing within the first opening formed in the musical instrument to allow the mounting flange to overlap a portion of the surface of the musical instrument; and
fastening the mounting flange to the surface of the musical instrument to secure the preamplifier assembly to the instrument,
wherein the preamplifier assembly includes an output connector connected to a face portion of the housing, the mounting flange being fastened to the musical instrument surface to allow unobstructed user access to the face portion of the housing and the output connector connected thereto.

41. The method of claim 40 wherein the musical instrument comprises an acoustic stringed instrument including a body, a bridge, and a saddle slot, wherein the second forming step includes forming the second opening through the bridge, and wherein the installing step includes inserting the pickup from inside the instrument body through the opening in the bridge for subsequent insertion in the saddle slot.

42. The method of claim 40 wherein the musical instrument comprises a stringed instrument, and wherein the first forming step includes forming the first opening in a side of a lower bout of the instrument.
